(19) United States
(12) Patent Application Publication
(10) Pub. No.: US 2019/0295083 A1
(43) Pub. Date: Sep. 26, 2019

(54) THE METHOD FOR EXECUTING A DIGITAL VALUE TRANSFER TRANSACTION AND THE DIGITAL VALUE TRANSFER SYSTEM FOR ITS IMPLEMENTATION

(71) Applicant: Tovarystvo z obmezhenoiu vidpovidalnistiu, Simcord, Kharkiv (UA)

(72) Inventor: Aleksandr KUD, Kharkiv (UA)

(21) Appl. No.: 16/339,839

(22) PCT Filed: Jun. 21, 2017
(86) PCT No.: PCT/UA2017/000068

§ 371 Date: Apr. 5, 2019

(30) Foreign Application Priority Data
Apr. 25, 2017 (UA) A201704103

(51) Int. Cl. G06Q 20/40; G06Q 20/10

(52) U.S. Cl. CPC G06Q 20/4012; G06Q 20/10

(57) ABSTRACT

The method for executing a digital value transfer transaction foresees entering (230, 430) by the payer the primary and secondary authentication artifacts specified by him/her and additional transaction execution conditions in the system. The primary authentication artifacts are created using a physical object. To complete the transaction, the recipient should enter (320, 520) the primary and secondary authentication artifacts specified by the payer and fulfill additional transaction execution conditions specified by the payer. The system for the method's implementation contains the processing server (101), authentication template storage server (102), verification module of authentication artifacts (103), and the public distributed ledger of transaction data (104).

### TECHNICAL FIELD

The claimed group of inventions is related to information technologies and intended to be used in the financial field, for management of rights to digital values, transfer of rights to digital values. The group of inventions can be used by companies, entrepreneurs and ordinary individuals.

### BACKGROUND ART

With the development and worldwide distribution of payment systems, non-cash settlements between ordinary people have also received the global distribution. For example, there is a typical situation when on an advertisement website one person finds information on the sale of goods placed by another person and makes a non-cash payment to the seller's card account.

There is a common situation when one person makes a non-cash transfer to the card account of another person in order to pay for any service that he/she provides (for example, cleaning the house, looking after the child, walking the dog).

There is also a typical situation when parents transfer money to their child in a cashless way by replenishing his/her card account. Or vice versa, adult children make a non-cash transfer to the card account of their parents providing them with financial assistance.

The situation when the cost equivalents of monetary units (electronic money, digital assets and other digital values) are used for making payments between people is becoming more frequent. In addition, such payments are made using computer and/or cellular networks of telecom operators without turning to traditional financial institutions such as banks or payment systems.

In all these cases the proposed method for executing a digital value transfer transaction and the system for its implementation can be used. It also should be noted that the listed cases do not limit the application field of the claimed method and system.

There is a known method for executing payment transactions, which foresees initiating the request by the payer to the payment system to execute a payment transaction in favor of the recipient, entering nominal value of the payment by the payer in the payment system, the recipient's name, the recipient's address, saving the recipient's name in the payment system, nominal value of the payment, the recipient's address, generating the transaction code by the system and sending it to the payer, giving the transaction nominal value and authentication code to the recipient by the payer, generating the request by the recipient to the payment system to receive the payment, entering the transaction code by the recipient in the n payment system, verifying the transaction code by the payment system, executing the transaction upon successful verification or cancelling the transaction if the verification is failed (see the description of Western Union system on the website https://www.westernunion.com/us/en/home.html).

The method is intended for executing transactions with cash and non-cash funds. The recipient is authenticated by his/her personal details and by the transaction code. The disadvantage of the method is the inability to execute transactions using other values than money. In addition, the method requires the obligatory indication of the recipient's name and his/her address and does not allow transactions to be executed in favor of anonymous recipients. Another disadvantage of the method is the inability of the payer to specify the conditions for executing a transaction (date, geographic location).

There is a known method for executing payment transactions, which foresees receiving from the recipient an invoice for payment, identifying a graphic image (signature or logo) on the account that identifies the recipient, identifying the recipient by recognizing the signatures and logos of the known recipients existing in the system, implementing the payment rule intended for the identified recipient. The system, which is intended to implement this method, contains a data processing server, data storage server of recipients and payment rule data, fax-server (application for patent US20130226798, IPC G06Q20/10, G06Q20/40, publication date 29 Aug. 2013).

The known system is focused on work automation with invoices for payment received by the payer from the recipients and is not intended for servicing transactions created on the initiative of the payer. The system is not able to execute transactions in favor of the recipients whose details have not been previously entered in the system and for whom the payment rules have not been established.

The closest analogue of the claimed method is the known method of executing payment transactions, which involves the consecutive initiating the request by the payer to the payment system for a transaction to transfer funds to the recipient, entering the recipient's name and the nominal value of the payment by the payer in the payment system, saving the transaction details in the payment system, in particular, the recipient's name entered by the payer, the nominal value of the payment entered by the payer, as well as the transaction execution conditions, authentication parameters, generating a request by the recipient to the payment system to receive funds from the payer, entering the authentication parameters by the recipient in the payment system, verifying by the payment system the authentication parameters entered by the recipient, verifying the transaction execution conditions, executing the transaction upon successful verification or cancelling the transaction if the verification is failed (application for patent EP 2743873, IPC G06Q20/40, publication date 18 Jun. 2014).

A distinctive feature of the known method is that the transaction execution conditions and authentication parameters are set by the payment system and cannot be established by the payer. The method does not allow the payer to establish the specific transaction conditions for each transaction made by him/her and the authentication parameters for the recipient. For example, the payer cannot specify that the transaction A can only be executed in three weeks and on condition that the recipient X is located in the city of Paris, while the transaction B can only be executed in five days and on condition that the recipient Y is located in the city of Barcelona.

Another disadvantage of the known method is the inability of the payer to set additional authentication parameters. For example, the payer cannot specify that the transaction A can only be executed on condition that the recipient X enters the pin code “97531” specified by the payer only for this transaction in the payment system and enters a photo of the postcard with the image of the Tower of Pisa in the payment system.

Inability of the payer to establish specific transaction conditions and authentication parameters makes the known method insufficiently reliable and inflexible in use.

In addition, this known method like the primary majority of other similar methods does not allow transactions to be executed in favor of the recipient whose name is unknown to the payer thereby ensuring a high level of security and reliability of the transaction.

The closest analogue of the claimed system is the known system for transferring funds, containing at least one processing server, authentication template storage server (application for patent EP 2743873, IPC G06Q20/40, publication date 18 Jun. 2014).

The disadvantage of the known system is the inability to enter and store additional authentication conditions and additional transaction execution conditions specified by the payer.

The task of the group of inventions is to create a method and system for digital value transfer which allow the payer when initiating a request to the system for executing a transaction at his/her own discretion to determine and enter additional transaction execution conditions (in particular, date and time of the transaction, desired time period of the transaction, data of geographic location of the recipient), to establish and enter additional authentication parameters (pin code, graphic image, audio record, video record, text), to securely store information on the completed transaction with the possibility of its further reconsideration if it is necessary.

### DISCLOSURE OF INVENTION

The set task concerning the method is achieved in such a way that in the known method of executing a transaction of digital value transfer that foresees the consecutive initiating a request by the payer to the digital value transfer system for executing a transaction of digital value transfer to the recipient, entering by the payer the nominal of the digital value to the digital value transfer system, and, if it is necessary the recipient's name, storing the transaction details in the digital value transfer system, in particular, the recipient's name, nominal of the digital value, transaction type, as well as transaction execution conditions, authentication parameters, creating a request by the recipient to the digital value transfer system to receive a digital value from the payer, entering the authentication parameters by the recipient in the digital value transfer system, verifying by the digital value transfer system the authentication parameters entered by the recipient, verifying by the digital value transfer system the transaction execution conditions, executing the transaction upon successful verification or cancelling the transaction upon unsuccessful verification, in accordance with the proposed technical solution, when initiating a request by the payer to the digital value transfer system for the transaction of digital value transfer to the recipient, the additional transaction execution conditions, transaction type, pin code specified by the payer are entered, the primary authentication artifact is created using the physical object and is entered in the system, the additional transaction execution conditions entered by the payer, transaction type, pin code, primary authentication artifact are saved in the system, the digital value of the nominal value specified by the payer is blocked in the payer's account, then the recipient is informed of the physical object used to create the primary authentication artifact, of the additional transaction execution conditions specified by the payer, the recipient is informed of the transaction identifier, of the pin code specified by the payer, when creating a request by the recipient for receiving a digital value, the pin code received from the payer is entered in the digital value transfer system, the primary authentication artifact is reproduced using a physical object and is entered in the system, then the digital value transfer system verifies the compliance with additional transaction execution conditions, which also includes comparing the pin code entered by the recipient with the pin code entered by the payer, and comparing the primary authentication artifact entered by the recipient with the primary authentication artifact entered by the payer, when executing the transaction the blocked digital value is written off the payer's account and is credited to the recipient's account, after the transaction is completed, the information about it is stored in the public distributed ledger.

It is possible to implement a method in which the desired date and time of the transaction entered by the payer are used as additional transaction execution conditions.

It is possible to implement a method in which the data entered by the payer on the desired time period of the transaction are used as additional transaction execution conditions.

It is possible to implement a method in which the data entered by the payer on the geographic location of the recipient are used as additional transaction execution conditions.

It is possible to implement a method in which a graphic image of any physical object created by the payer and metadata of this image are used as the primary authentication artifact.

It is possible to implement a method in which a series of graphic images of any physical object created by the payer and metadata of these images are used as the primary authentication artifact.

It is possible to implement a method in which, additionally, when initiating a request by the payer to the digital value transfer system for executing a transaction of digital value transfer to the recipient, the secondary authentication artifact specified by the payer is entered in the system, saved in the system, then the recipient is informed about it, when creating the request by the recipient for receiving a digital value the secondary authentication artifact is entered in the system, after which the system compares the secondary authentication artifact entered by the recipient with the secondary authentication artifact entered by the payer.

It is possible to implement a method in which an audio record entered by the payer and metadata of this audio record are used as the secondary authentication artifact.

It is possible to implement a method in which a video record entered by the payer and metadata of this video record are used as the secondary authentication artifact.

It is possible to implement a method in which the text entered by the payer and metadata of this text are used as the secondary authentication artifact.

It is possible to implement a method in which, when initiating a request by the payer to the digital value transfer system for executing a transaction of digital value transfer to the recipient, an anonymous recipient is stated in the recipient's name line.

The set task concerning the system is achieved in such a way that in the known digital value transfer system which includes at least one processing server, the authentication template storage server according to the proposed technical solution is configured with the ability to save the additional transaction execution conditions, authentication artifacts and the pin code entered by the payer, the system includes the verification module of authentication artifacts, pin code and of additional transaction execution conditions configured with the ability to compare the authentication artifacts and the pin code entered by the payer and saved on the server with the authentication artifacts and the pin code entered by the recipient, the system includes a public distributed ledger of transaction data.

It is possible to implement a system in which the verification module of authentication artifacts, pin code and of additional transaction execution conditions is configured with the ability to compare the graphic image and its metadata entered by the payer with the graphic image and its metadata entered by the recipient.

It is possible to implement a system in which the verification module of authentication artifacts, pin code and of additional transaction execution conditions is configured with the ability to compare the audio record and its metadata entered by the payer with the audio record and its metadata entered by the recipient.

It is possible to implement a system in which the verification module of authentication artifacts, pin code and of additional transaction execution conditions is configured with the ability to compare the video record and its metadata entered by the payer with the video record and its metadata entered by the recipient.

It is possible to implement a system in which the verification module of authentication artifacts, pin code and of additional transaction execution conditions is configured with the ability to compare the text and its metadata entered by the payer with the text and its metadata entered by the recipient.

It is possible to implement a system in which the verification module of authentication artifacts, pin code and of additional transaction execution conditions is configured with the ability to compare the transaction execution date entered by the payer with the current date.

It is possible to implement a system in which the verification module of authentication artifacts, pin code and of additional transaction execution conditions is configured with the ability to compare the data of the geographic location of the recipient entered by the payer with the data of the current geographic location of the recipient.

It is possible to implement a system in which the public distributed ledger of transaction data is configured as a network of interconnected hardware-software complexes.

The technical result of the claimed method is to increase the reliability of the transaction by entering additional transaction execution conditions, pin code and primary authentication artifacts specified by the payer in the digital value transfer system when initiating a request by the payer to the system for executing a transaction and by further entering the primary authentication artifacts by the recipient in the system.

In particular, the security of the transaction is increased by using the graphic image of any physical object chosen by the payer and the metadata of this image as the primary authentication artifact. Accordingly, to form and enter the primary authentication artifact, the recipient should have at his/her disposal the same physical object that the payer had. Along with the necessity to enter a pin code, this solution excludes the possibility of receiving a digital value by a fraudster who will try to imitate the recipient.

The security of the transaction is further improved by the ability of the payer to specify the secondary authentication artifacts, such as: video record with its metadata, audio record with its metadata, text with its metadata.

It is possible to execute the transaction at the date and time specified by the payer, or at any desired time period (for example, with a delay of several days, weeks, months) and in the geographic location of the recipient determined by the payer. It becomes possible by using the date, time and transaction time period specified by the payer as additional transaction execution conditions, as well as by using the data of geographic location of the recipient and further verification of these data. In this case, each transaction, even with any time delay is executed only in one step—by writing off the previously blocked digital value from the payer's account and crediting it to the recipient's account. It also increases the transaction security by eliminating the use of the interim transfers to correspondent and transit accounts that are used by banking institutions and payment systems.

It is possible to safely store information about a transaction by saving it to the public distributed ledger. Since the public distributed ledger is stored on an unlimited number of interconnected hardware-software complexes, the possibility of the transaction information forgery is excluded.

In addition, it becomes possible to execute transactions in favor of an anonymous recipient (i.e. a recipient whose name is not known to the payer) by maintaining the high level of security and reliability of the transaction due to the recipient's identification by primary and/or secondary authentication artifacts only.

The technical result of the claimed system is to provide the payer with an opportunity at his/her own discretion to establish and enter additional transaction execution conditions and additional authentication parameters of the recipient in the system, which is achieved by implementing an authentication template storage server with the ability to save additional transaction execution conditions, authentication artifacts and pin code entered by the payer.

The technical result of the claimed system is also the ability to compare the authentication artifacts entered by the payer with the authentication artifacts entered by the recipient, which in its turn becomes possible by including a verification module in the system capable of comparing graphic images and their metadata, audio records and their metadata, video records and their metadata, texts and their metadata. This, in its turn, makes it possible to execute transactions even if the recipient's name is unknown to the payer (transactions in favor of the anonymous recipient).

The technical result of the claimed system is also to increase the information storage reliability of a transaction by implementing the public distributed ledger in which it is stored as a network of interconnected hardware-software complexes. Since the public distributed ledger is stored on an unlimited number of interconnected hardware-software complexes, the possibility of transaction information forgery is excluded. In case of damage or falsification of the ledger on a single hardware-software complex, it will be replaced by an intact copy from other hardware-software complexes.

The technical result of the claimed system is also to verify the observance of additional transaction execution conditions specified by the payer that becomes possible by implementing a verification module capable of comparing the data of the geographic location of the recipient entered by the payer with the data of the current geographic location of the recipient, and the transaction date entered by the payer with the current date.

The main point of the claimed method for executing a digital value transfer transaction and the digital value transfer system for its implementation will be described in detail in the following materials.

### Glossary of Terms Used in the Document

Digital Value means an asset (property or other values) shown as an alphanumeric identifier and registered in the public distributed ledger (blockchain).

Metadata means information about other information or data related to additional information about the content or the object. Metadata reveals information about features and properties characterizing any entities that allow you to automatically search and manage them in the large information flows.

Bitbon means a digital derivative financial instrument having an identifier and nominal value in the amount determined in accordance with the procedure stipulated by Bitbon Public Contract, which corresponds to a certain part of property rights to Assets. Any operations with Bitbon (Bitbon issuing, its transfer from one owner to another, splitting of nominal value and other operations) are recorded in the public distributed ledger as data that cannot be deleted or modified.

Bitbon attributes are:
Identifier—a unique sequence of alphabetic and numeric characters;
Nominal value—a positive real number corresponding to the part of the user's property rights to Assets;
Records in the public distributed ledger, which register all operations with each Bitbon;
Bitbon Public Contract.

Public Contract means a digital document that defines and regulates the field of application of the digital value transfer system, system operation rules, and authentication parameters of users.

Payer means a user of the system initiating a transaction to transfer Digital Value owned by him/her to another user.

Recipient means a user of the system receiving the Digital Value from the Payer.

Payer Authentication Parameters mean a sequence of data identifying the Payer and determined in accordance with the Public Contract

Recipient Authentication Parameters mean a sequence of data identifying the Recipient and determined in accordance with the Public Contract.

Authentication Artifact means a sequence of digital data describing characteristics of a physical object, phenomenon. For example, the Authentication Artifact can be digital data describing the postcard appearance.

Primary Authentication Artifact means a digital graphic image (or a series of images) created by the Payer of any physical object and the Metadata of this image (these images). An example of the Primary Authentication Artifact can be a digital graphic image of the postcard and the Metadata of this image.

Secondary Authentication Artifact means a digital audio record (video record, text) entered by the Payer and the Metadata of this audio record (video record, text).

An example of the Secondary Authentication Artifact can be a digital audio record of an automobile horn and the Metadata of this audio record.

Transaction Execution Conditions mean general Transaction Conditions in the system defined in accordance with the Public Contract.

Additional Transaction Execution Conditions mean conditions specified by the Payer for each specific transaction in the system, in particular, the transaction date, data on the desired transaction time period, data on the Recipient's geographic location.

### BRIEF DESCRIPTION OF DRAWINGS

The declared method and system are illustrated with the drawings:

FIG. 1—composition of the digital value transfer system and interaction of its components.

FIG. 2—flow chart of the method implementation for executing a digital value transfer transaction using electronic money as an example.

FIG. 3—flow chart of the method implementation for executing a digital value transfer transaction using electronic money as an example (flow chart continued from FIG. 2).

FIG. 4—flow chart of the method implementation for executing a digital value transfer transaction using electronic money as an example in favor of an anonymous recipient.

FIG. 5—flow chart of the method implementation for executing a digital value transfer transaction using electronic money as an example in favor of an anonymous recipient (flow chart continued from FIG. 4).

FIG. 6—flow chart of the method implementation for executing a digital value transfer transaction using Bitbon as an example.

FIG. 7—flow chart of the method implementation for executing a digital value transfer transaction using Bitbon as an example (flow chart continued from FIG. 6).

### DETAILED DESCRIPTION OF DRAWINGS

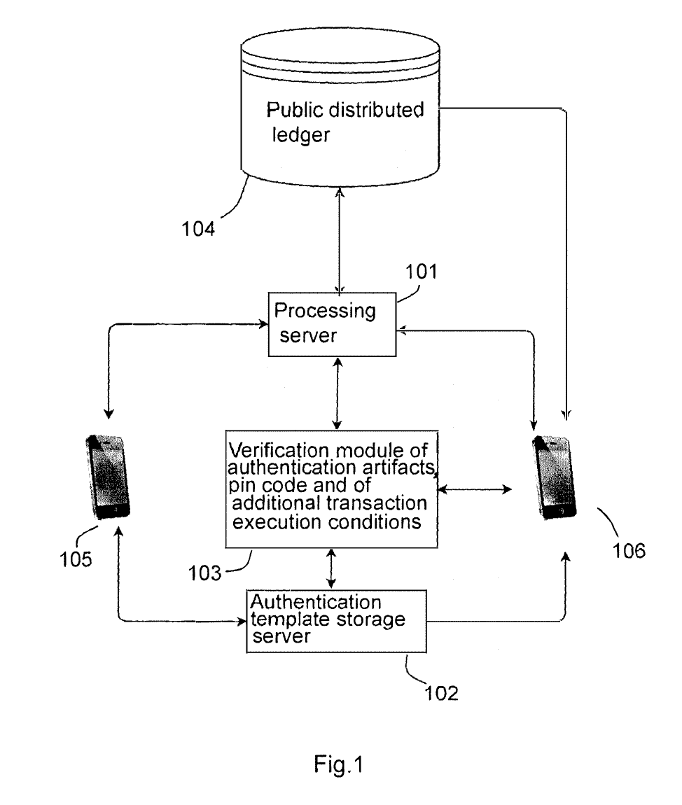

Let us consider the composition of the declared Digital Value transfer system (FIG. 1).

The Digital Value transfer system contains at least one processing server 101 or several distributed processing servers 101, authentication template storage server 102, verification module 103 of Authentication Artifacts, pin code and of Additional Transaction Execution Conditions, public distributed ledger 104. The Payer interacts with the system using the communicator 105, the Recipient interacts with the system using the communicator 106. The communicators 105 and 106 can be programmable devices with the ability to connect to the Internet, in particular, smartphones, desktop computers, laptops, tablets etc.

The server 102 is configured with the ability to save Additional Transaction Execution Conditions, Authentication Artifacts and pin code entered by the Payer. For this purpose, the server 102 contains at least one medium for recording data on it with program instructions to the processor and data about Additional Transaction Execution Conditions and Authentication Artifacts. The server 102 also contains the processor capable of executing instructions recorded on storage media for receiving and further storage of data in digital form concerning Additional Transaction Execution Conditions and Authentication Artifacts.

The verification module 103 of Authentication Artifacts, pin code and of Additional Transaction Execution Conditions is configured with the ability to compare the Authentication Artifacts and the pin code entered by the Payer and saved on the server 102 with the Authentication Artifacts and the pin code entered by the Recipient. The verification module 103 may be configured as a separate hardware-software complex containing the processor capable of executing instructions recorded on storage media for processing graphic, audio, video and text information.

The public distributed ledger of transactions 104 is configured as a network of interconnected hardware-software complexes.

All components of the system are interconnected with the help of modern means of telecommunication.

Let us consider the implementation of the claimed method for executing a transaction of Digital Value transfer and functioning of the declared system using the examples.

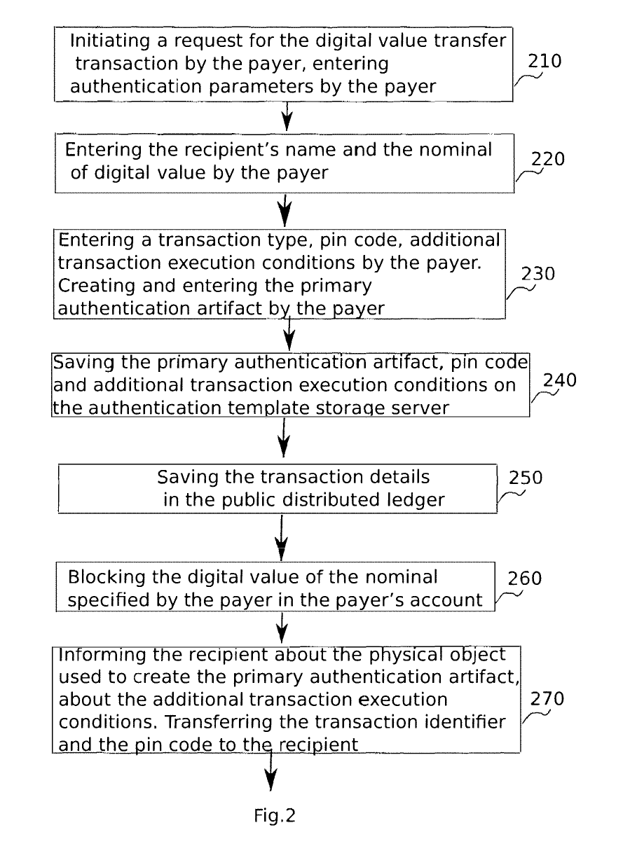

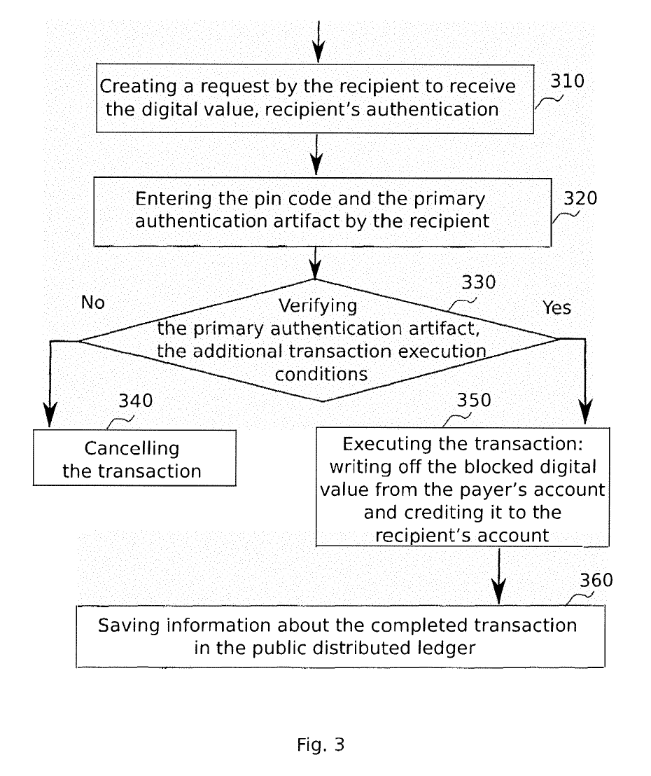

### Example 1. Method for Executing a Transaction of Digital Value Transfer Using Electronic Money as an Example (FIG. 2, FIG. 3)

The Payer initiates a transaction request to transfer Digital Value as a certain amount of electronic money from the Payer to the Recipient (step 210). At the same time, the Payer is authenticated in the system in accordance with the Public Contract (for example, by entering login and password). The transaction request is made using the Payer's communication device 105, which interacts with the system by means of modern communication facilities. The Recipient's name (for example, John Smith) and the nominal of Digital Value—the number of electronic money units are entered in the system (step 220).

A transaction type (for example, private), pin code (for example, “12345”), Additional Transaction Execution Conditions are entered, the Primary Authentication Artifact is created and entered (step 230). For example, the Additional Transaction Execution Conditions may become the date of Sep. 1, 2019 entered by the Payer when the Payer wishes to execute a transaction of Digital Value transfer to the Recipient, as well as the name of the city of Baden-Baden where the Recipient should arrive in to receive this Digital Value.

To create the Primary Authentication Artifact, the Payer can use, for example, a postcard with the photo of the Tower of Pisa. The Payer takes a photo of this postcard with his/her communication device 105. The software of the communication device 105 saves the postcard image in digital form in a graphic file format, which, in addition to image data, contains the Metadata relating to this image. In this case, the Primary Authentication Artifact will be the graphic image of the postcard created by the Payer and digitally saved and the Metadata of this image.

The Primary Authentication Artifact, pin code, transaction type and Additional Transaction Execution Conditions are saved on the server 102 (step 240).

The pending transaction details are saved in the public distributed ledger: Recipient's name, nominal of the Digital Value, transaction type (step 250).

Next, the Digital Value of the nominal specified by the Payer is blocked in the Payer's account (step 260).

Then the Recipient is informed of the created transaction. He/she can be informed by the system in automated mode or by the Payer. The Payer informs the Recipient in any convenient way and at any convenient time about the physical object used to create the Primary Authentication Artifact, about the specified Additional Transaction Execution Conditions, informs the Recipient about the transaction identifier and the pin code (step 270).

The request is made to the processing servers 101 to receive the Digital Value by the Recipient (step 310). At the same time, the Recipient is authenticated in the system in accordance with the Public Contract (for example, by entering a login and password). The request is made using the Recipient's communication device 106.

The processing servers 101 validate the Recipient's request, and in case its validation is possible, a request for issuing the authentication templates is sent to the artifact verification module 103, which, in its turn, sends the request to the authentication template storage server 102. The server 102 sends the Recipient the instructions for creating the Primary Authentication Artifact to the communication device 106. According to the instructions received, the Recipient should enter a pin code “12345” received from the Payer, take a photo of the postcard with the image of the Tower of Pisa received from the Payer, generate the Metadata of this image using the software and thereby reproduce the Primary Authentication Artifact. The Primary Authentication Artifact reproduced by the Recipient is sent to the verification module 103 (step 320).

The server 102 sends the Primary Authentication Artifact entered by the Payer, which is saved on it, to the verification module 103. The server 102 also sends the Additional Transaction Execution Conditions saved on it to the verification module 103. Then, the Primary Authentication Artifact and Additional Transaction Execution Conditions are verified in the verification module 103 (step 330). The Primary Authentication Artifact is verified by comparing the graphic-image of the postcard and its Metadata entered by the Payer with the graphic image of the postcard and its Metadata entered by the Recipient.

The Additional Transaction Execution Conditions are also verified in the verification module 103 (step 330). For this purpose, the date of Sep. 1, 2019 entered by the Payer is compared with the current date, and the name of the city of Baden-Baden entered by the Payer is compared with the data of the current geographic location of the Recipient.

If the Primary Authentication Artifact or at least one of the Additional Transaction Execution Conditions is not verified, the transaction is canceled (step 340).

Upon successful verification of the Primary Authentication Artifact and the Additional Transaction Execution Conditions, the transaction of the Digital Value transfer from the Payer to the Recipient is successfully executed (step 350) by crediting the Digital Value from the Payer's account to the Recipient's account by the processing server 101. Next, the record on a completed transaction is saved in the public distributed ledger 104 (step 360).

The message about the transaction completion is sent to the Payer's communicator 105 and to the Recipient's communicator 106. The templates of Authentication Artifacts on the server 102 are designated as extracted and they are deleted.

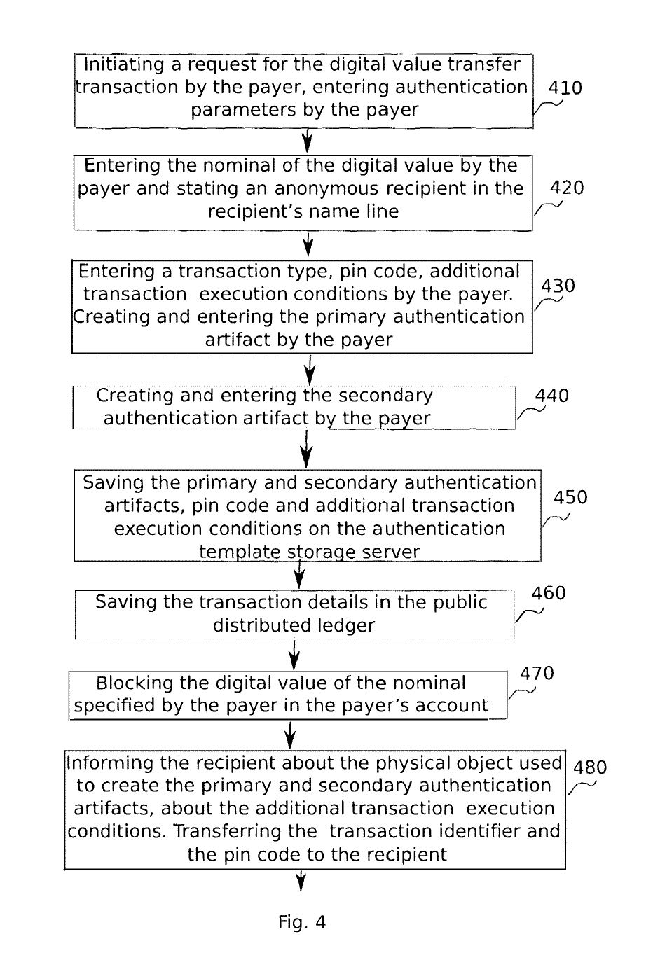

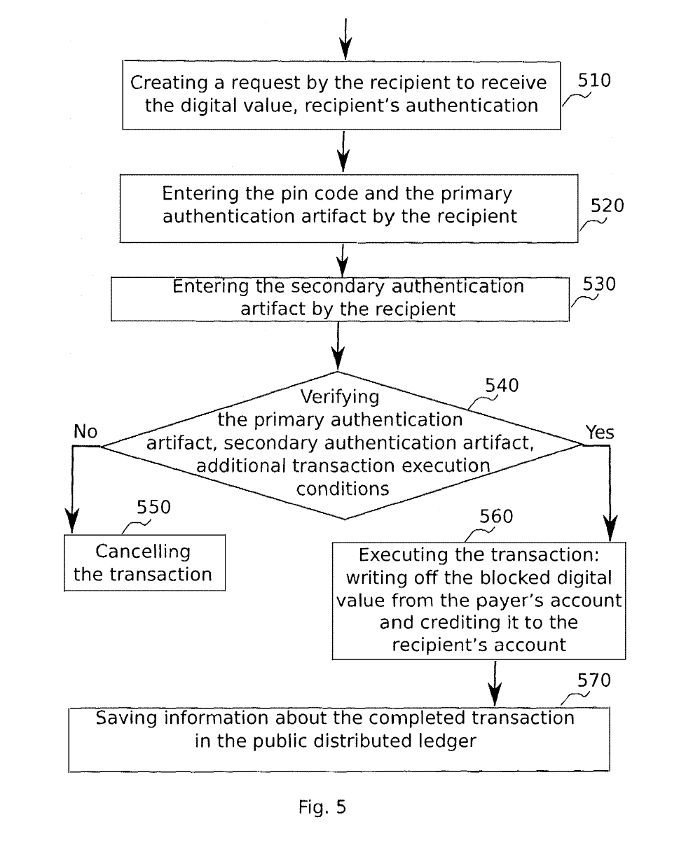

### Example 2. Method for Executing a Transaction of Digital Value Transfer Using Electronic Money as an Example in Favor of an Anonymous Recipient (FIG. 4, FIG. 5)

The Payer initiates a transaction request to transfer the Digital Value as a certain amount of electronic money from the Payer to the anonymous Recipient (step 410). At the same time, the Payer is authenticated in the system in accordance with the Public Contract (for example, by entering a login and password). The transaction request is made using the Payer's communication device 105, which interacts with the system by means of modern communication methods.

An anonymous Recipient (for example, Anonymous or John Doe) and the nominal of Digital value—the number of electronic currency units are entered in the system (step 420). A transaction type (for example, public), pin code (for example, “12345”), Additional Transaction Execution Conditions are entered, the Primary Authentication Artifact is created and entered (step 430). For example, Additional Transaction Execution Conditions may become the date of Sep. 1, 2019 entered by the Payer when the Payer wishes to execute a transaction of Digital Value transfer to the Recipient, as well as the name of the city of Munich where the Recipient should arrive in to receive this Digital Value.

To create the Primary Authentication Artifact, the Payer can use, for example, a half-full glass bottle of Coca-Cola. The Payer takes a photo of the bottle with his communication device 105. The software of the communication device 105 saves the bottle image in digital form in a graphic file format which, in addition to image data, contains the Metadata relating to this image. In this case, the Primary Authentication Artifact will be the graphic image of the Coca-Cola bottle created and digitally saved by the Payer and the Metadata of this image.

To create the Secondary Authentication Artifact, the Payer can use, for example, “Yellow Submarine” song of the Beatles. The Payer downloads this song to his/her communication device 105. The software of the communication device 105 saves the song in digital form in an audio file format which, in addition to sound data, contains the Metadata relating to this sound. In this case, the Secondary Authentication Artifact will be the digital audio record and the Metadata of this audio record (step 440).

Next, the Primary and Secondary Authentication Artifacts, pin code, transaction type and Additional Transaction Execution Conditions are saved on the server 102 (step 450).

The pending transaction details are saved in the public distributed ledger 104: anonymous Recipient, nominal of Digital Value, transaction type (step 460).

Next, the Digital Value of the nominal specified by the Payer is blocked in the Payer's account (step 470).

Then, the Recipient is informed about the created transaction. The Payer informs the Recipient in any convenient way and at any convenient time about the physical object used to create the Primary Authentication Artifact, about the song used to create the Secondary Authentication Artifact, about the Additional Transaction Execution Conditions specified by him/her, and informs the Recipient about the transaction identifier and the pin code (step 480). For example, the Payer may inform the Recipient by sending a personal message via e-mail. It is also possible to inform an indefinite number of persons by posting publicly available information about the created transaction, Primary and Secondary Authentication Artifacts, and Additional Transaction Execution Conditions. Such method of informing may be useful to the Payer for conducting large-scale advertising campaigns and prize drawings, when it is not known in advance who exactly will be the Recipient. The main point of the advertising campaign may be, for example, as follows: the Recipient of the transaction will be a person from the city of Munich who will be the first to buy a Coca-Cola bottle on Sep. 1, 2019, and who will enter the Primary and Secondary Authentication Artifacts and the pin code specified by the Payer in the system.

Next, a request is made by the Recipient to the processing servers 101 to receive the Digital Value (step 510). At the same time, the Recipient is authenticated in the system in accordance with the Public Contract (for example, by entering a login and password). The request is made by using the Recipient's communication device 106.

The processing servers 101 validate the Recipient's request, and in case its validation is possible, a request is transferred for issuing authentication templates to the artifact verification module 103, which in its turn, sends a request to the authentication template storage server 102. The server 102 sends instructions to the Recipient's communication device 106 for creating the Primary and Secondary Authentication Artifacts. In accordance with the instructions received, the Recipient should enter the pin code “12345” received from the Payer, take a photo of the half-full bottle of Coca-Cola, download “Yellow Submarine” song of the Beatles to his/her communication device 106, using the software generate the Metadata of the image and audio record and, thereby, reproduce the Primary and Secondary Authentication Artifacts. The Primary Authentication Artifact reproduced by the Recipient (step 520) and the Secondary Authentication Artifact reproduced by the Recipient (step 530) are transmitted to the verification module 103.

The server 102 sends the Primary and Secondary Authentication Artifacts entered by the Payer and saved on it to the verification module 103. The server 102 also sends the Additional Transaction Execution Conditions saved on it to the verification module 103. Next, the Primary and Secondary Authentication Artifacts and Additional Transaction Execution Conditions are verified (step 540) in the verification module 103. The Primary Authentication Artifact is verified by comparing the graphic image of the bottle and its Metadata entered by the Payer with the graphic image of the bottle and its Metadata entered by the Recipient. The Secondary Authentication Artifact is verified by comparing the audio record and its Metadata entered by the Payer with the audio record and its Metadata entered by the Recipient.

The Additional Transaction Execution Conditions are also verified in the verification module 103 (step 540). For this purpose, the date of Sep. 1, 2019 entered by the Payer is compared with the current date, as well as the name of the city of Munich entered by the Payer is compared with the data of the current geographic location of the Recipient.

If the Primary Authentication Artifact or Secondary Authentication Artifact, or at least one of the Additional Transaction Execution Conditions is not verified, the transaction is canceled (step 550).

Upon successful verification of the Primary and Secondary Authentication Artifacts, as well as of all Additional Transaction Execution Conditions, the transaction for transferring the Digital Value from the Payer to the anonymous Recipient is successfully executed (step 560) by crediting the Digital Value transfer from the Payer's account to the Recipient's account by the processing server 101. Next, a record on the completed transaction is saved in the public distributed ledger 104 (step 570).

A message about the transaction completion is sent to the Recipient's communicator 105 and the Recipient's communicator 106. The templates of Authentication Artifacts on the server 102 are designated as extracted and they are deleted.

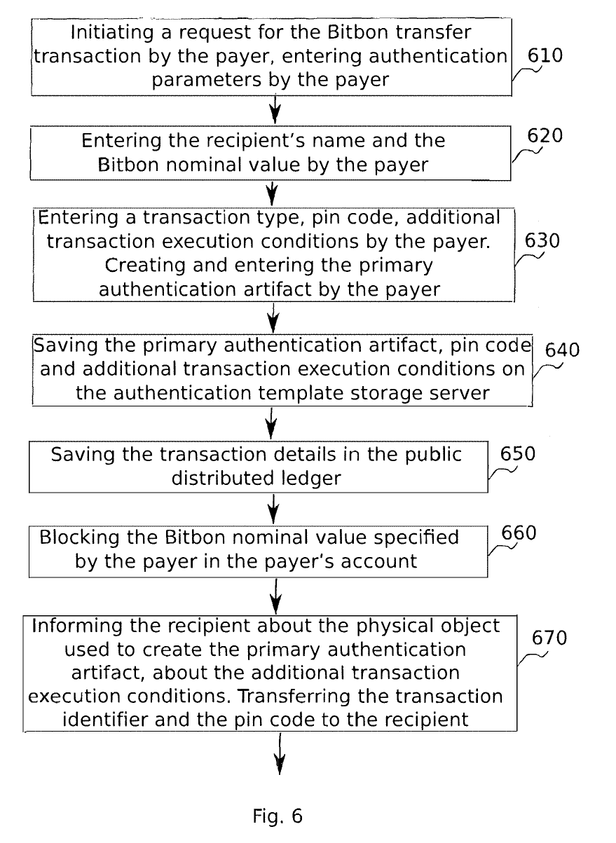

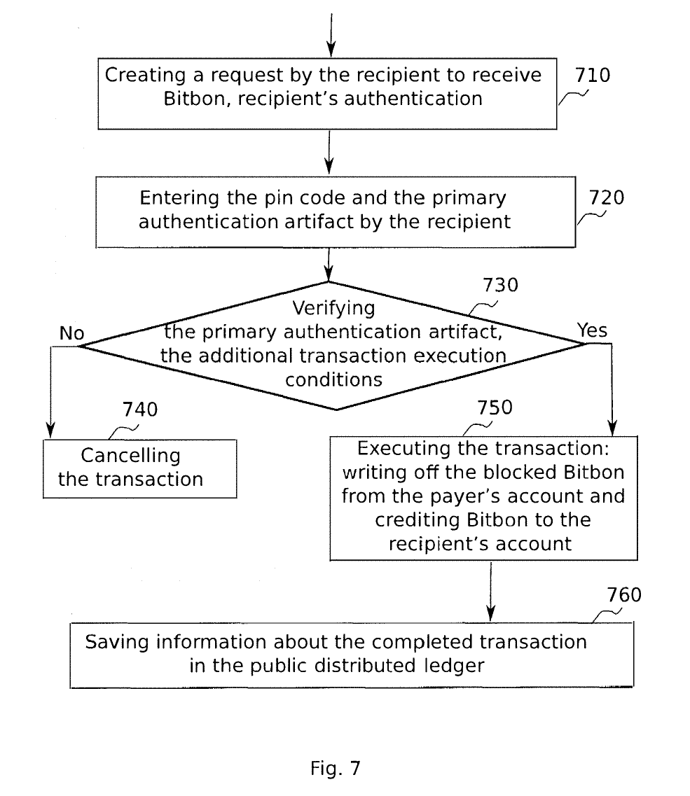

### Example 3: Method for Executing a Transaction of Digital Value Transfer Using Bitbon as an Example (FIG. 6, FIG. 7)

Before transferring the Digital Value as Bitbon, the issuing procedure of Bitbon is implemented. This procedure is described in detail by the applicant in the application for invention No. a201701536, which was filed to Ukrpatent on 20 Feb. 2017.

The Payer (Bitbon owner) initiates a transaction request to transfer Digital Value as Bitbon from the Payer to the Recipient in accordance with the Bitbon Public Contract (step 610). The transaction request is made using the Payer's communication device 105, which interacts with the system by means of modern communication facilities.

The Recipient's name (for example, John Smith) and the nominal of Digital Value—the amount of Bitbon are entered in the system (step 620).

The transaction type (for example, private), pin code (for example, “12345”), Additional Transaction Execution Conditions are entered, the Primary Authentication Artifact is created and entered (step 630). For example, Additional Transaction Execution Conditions may become the date of Sep. 1, 2019 entered by the Payer when the Payer wishes to execute the Bitbon transfer transaction to the Recipient, and the name of the city of London where the Recipient should arrive in to receive Bitbon.

To create the Primary Authentication Artifact, the Payer can use, for example, a statuette in the form of a cat. The Payer takes a photo of the cat statuette with his communication device 105. The software of the communication device 105 saves the image of the statuette in digital form in a graphic file format which, in addition to the image data, contains the Metadata relating to this image. In this case, the Primary Authentication Artifact will be the graphic image of the statuette created and digitally saved by the Payer and the Metadata of this image.

Next, the Primary Authentication Artifact, pin code, transaction type and Additional Transaction Execution Conditions are saved on the server 102 (step 640).

The pending transaction details: Recipient's name, Bitbon nominal value, transaction type are saved in the public distributed ledger 104 (step 650).

Next, the Bitbon nominal value specified by the Payer is blocked in the Payer's account (step 660).

Then, the Recipient is informed about the created transaction. He/she can be informed by the system in automated mode or by the Payer. The Payer in any convenient way and at any convenient time informs the Recipient about the physical object used to create the Primary Authentication Artifact, about the specified Additional Transaction Execution Conditions, transfers the transaction identifier and the pin code to the Recipient (step 670).

A request is made to the processing servers 101 to receive the Digital Value by the Recipient (step 710). At the same time, the Recipient is authenticated in the system in accordance with the Public Contract (for example, by entering a login and password). The request is made using the Recipient's communication device 106. The processing servers 101 validate the Recipient's request, and in case its validation is possible, the request is sent for issuing authentication templates to the artifact verification module 103, which in its turn, sends a request to the authentication template storage server 102.

The server 102 sends the Recipient the instructions for creating the Primary Authentication Artifact to the communication device 106. In accordance with the instructions received, the Recipient should enter the pin code “12345” received from the Payer, take a photo of the cat statuette received from the Payer, generate the Metadata of this image using the software, and thereby reproduce the Primary Authentication Artifact. The Primary Authentication Artifact reproduced by the Recipient is sent to the verification module 103 (step 720).

The server 102 sends the Primary Authentication Artifact entered by the Payer to the verification module 103. The server 102 also sends the Additional Transaction Execution Conditions saved on it to the verification module 103. Next, the Primary Authentication Artifact and the Additional Transaction Execution Conditions are verified in the verification module 103 (step 730). The Primary Authentication Artifact is verified by comparing the graphic image of the cat statuette and its Metadata entered by the Payer with the graphic image of the cat statuette and its Metadata entered by the Recipient.

Additional Transaction Execution Conditions are also verified in the verification module 103 (step 730). For this purpose, the date of Sep. 1, 2019 entered by the Payer is compared with the current date, as well as the name of the city of London entered by the Payer is compared with the data of the current geographic location of the Recipient.

If the Primary Authentication Artifact or at least one of the Additional Transaction Execution Conditions is not verified, the transaction is canceled (step 740).

Upon successful verification of the Primary Authentication Artifact and the Additional Transaction Execution Conditions, the specified transaction of Bitbon transfer from the Payer to the Recipient is successfully executed (step 750) by crediting Bitbon from the Payer's account to the Recipient's account via the processing server 101. Next, a record on the executed transaction is saved in the public distributed ledger 104 (step 760).

A message about the transaction completion is sent to the Payer's communicator 105 and the Recipient's communicator 106. The templates of Authentication Artifacts on the server 102 are designated as extracted and they are deleted.

The above-mentioned examples of using the claimed method and system only illustrate the possibilities of their implementation and in no case limit the application sphere of the claimed method and system.

1-19. (canceled)

20. A method for executing a digital value transfer transaction, the method comprising:
receive a transaction request by a payer for executing a transaction of a digital value from a payer account associated with the payer to a recipient account associated with a recipient, wherein the transaction request includes the digital value of the transaction, a recipient identification associated with the recipient, at least one transaction authentication artifact, and a transaction pin code;
receiving, from the recipient associated with the recipient identification, a recipient authentication artifact and a recipient pin code; and
transferring the digital value of the transaction request from the payer account to the recipient account when the recipient pin code matches the payer pin code, and the recipient authentication artifact matches the payer authentication artifact.

21. The method of claim 20, further comprising communicating a request to the recipient, wherein the request includes instructions for the recipient to input the recipient authentication artifact and the recipient pin code.

22. The method of claim 20, further comprising the payer communicating identification of a physical object associated with the transaction authentication artifact to the recipient.

23. The method of claim 20, further comprising the payer communicating the transaction pin code to the recipient.

24. The method of claim 20, further comprising storing the transaction request in an authentication template storage server associated with the payer account including the at least one transaction authentication artifact and the transaction pin code.

25. The method of claim 20, further comprising storing the completed transaction in a public distributed ledger associated with the payer account, wherein the completed transaction includes the recipient identification and the digital value.

26. The method of claim 20, wherein the transaction authentication artifact includes image data of a transaction physical object, wherein the recipient authentication artifact includes image data of a recipient physical object, wherein the transaction authentication artifact matches the recipient authentication artifact when the transaction physical object in the transaction authentication artifact matches the recipient physical object in the recipient authentication artifact.

27. The method of claim 20, wherein the transaction authentication artifact includes transaction audio data, wherein the recipient authentication artifact includes recipient audio data, wherein the transaction authentication artifact matches the recipient authentication artifact when the transaction audio data in the transaction authentication artifact matches the recipient audio data in the recipient authentication artifact.

28. The method of claim 20, wherein the transaction authentication artifact includes transaction video data, wherein the recipient authentication artifact includes recipient video data, wherein the transaction authentication artifact matches the recipient authentication artifact when the transaction video data in the transaction authentication artifact matches the recipient video data in the recipient authentication artifact.

29. The method of claim 20, further comprising receiving a transaction execution condition from the payer, wherein the transaction execution condition includes a time frame and a geographic area, wherein transferring the digital value of the transaction request from the payer account to the recipient account only occurs when the recipient authentication artifact and the recipient pin code are received within the time frame and wherein data related to the recipient authentication artifact and the recipient pin code are received from the geographic area.

30. A system for executing a digital value transfer transaction, the system comprising:
a public distributed ledger including a plurality of payer accounts and recipient accounts; and
a processing server in communication with the public distributed ledger, wherein the processing server is configured to
receive a transaction request by a payer for executing a transaction of a digital value from a payer account to a recipient account, wherein the transaction request includes the digital value of the transaction, a recipient identification associated with the recipient, at least one transaction authentication artifact, and a transaction pin code,
store the received transaction request associated with the payer account in an authentication template storage server in communication with the processing server,
receive, from the recipient associated with the digital value transfer transaction, the recipient identification, a recipient authentication artifact, and a recipient pin code,
execute the transaction by transferring the digital value of the transaction request from the payer account to the recipient account when the recipient identification matches the recipient identification associated with the transaction request, the recipient pin code matches the payer pin code, and the recipient authentication artifact matches the payer authentication artifact, and
record the executed transaction associated with the payer account in the public distributed ledger.

31. The system of claim 30, wherein the processing server is configured to communicate a request to the recipient, wherein the request includes instructions for the recipient to submit the recipient authentication artifact and the recipient pin code.

32. The system of claim 30, wherein the processing server is configured to display the public distributed ledger of executed transactions on a user interface.

33. The system of claim 30, wherein the controller is configured to store in the public distributed ledger the received recipient identification, the at least one transaction authentication artifact, and the transaction pin code associated with the payer account.

34. The system of claim 30, wherein the transaction authentication artifact includes image data of a transaction physical object, wherein the recipient authentication artifact includes image data of a recipient physical object, wherein the transaction authentication artifact matches the recipient authentication artifact when the transaction physical object in the transaction authentication artifact matches the recipient physical object in the recipient authentication artifact.

35. The system of claim 30, wherein the transaction authentication artifact includes transaction audio data, wherein the recipient authentication artifact includes recipient audio data, wherein the transaction authentication artifact matches the recipient authentication artifact when the transaction audio data in the transaction authentication artifact matches the recipient audio data in the recipient authentication artifact.

36. The system of claim 30, wherein the transaction authentication artifact includes transaction video data, wherein the recipient authentication artifact includes recipient video data, wherein the transaction authentication artifact matches the recipient authentication artifact when the transaction video data in the transaction authentication artifact matches the recipient video data in the recipient authentication artifact.

37. The system of claim 30, wherein the processing server is configured to receive a transaction execution condition from the payer, wherein the transaction execution condition can include a time frame and a geographic area, wherein transferring the digital value of the transaction request from the payer account to the recipient account only occurs when the recipient authentication artifact and the recipient pin code are received within the time frame and wherein data related to the recipient authentication artifact and the recipient pin code are received from the geographic area.
